(19) United States
(12) Patent Application Publication
(10) Pub. No.: US 2004/0246621 A1
(43) Pub. Date: Dec. 9, 2004

(54) Magnetic head whose composite magnetic core is recessed from air bearing surface

(75) Inventors: Youji Maruyama, Iruma (JP); Tadayuki Iwakura, Odawara (JP); Makoto Morijiri, Ninomiya (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Global Storage Technologies Japan, Ltd., Odawara-shi (JP)

(21) Appl. No.: 10/808,251

(22) Filed: Mar. 23, 2004

(30) Foreign Application Priority Data
Mar. 26, 2003 (JP) 2003-084089

(51) Int. Cl. G11B 5/147

(52) U.S. Cl. 360/126

(57) ABSTRACT

A magnetic head capable of preventing magnetic flux leakage at a write head of the magnetic head and suitably used for achieving high recording density. The write head is characterized in that a lower core had a flare on a side of an air bearing surface and a facet of the lower core is recessed at least from the air bearing surface.

### CROSS REFERENCE TO RELATED APPLICATION

This application claims priority from Japanese Patent Application No.2003-084089, filed Mar. 26, 2003, the entire disclosure of which is incorporated by reference for all purposes.

### BACKGROUND OF THE INVENTION

The present invention relates generally to magnetic heads and more particularly to write heads for use in a disk storage unit.

The following patent documents are referred to below by ordinal number, and are hereby incorporated by reference:

1. Japanese Patent Laid-open No. 2000-76620;

2. Japanese Patent Laid-open No.2002-123910; and

3. Japanese Patent Laid-open No. 11-7609.

The disk storage unit is characterized by its high reliability as well as large capacity and widely used in the field of information storage supporting today's information technology society. As the quantity of available information increases, it follows that that the performance of the disk storage unit need to be improved for processing a large quantity of information in a shorter amount of time.

FIG. 2 includes top plan and side views of a magnetic disk drive in which a conventional magnetic head or the magnetic head of the present invention can be used. A recording medium 2 (in reality, there are a plurality of media 2-1 to 2-4) is directly connected with a motor 3 and has a function of rotating at the time of inputting and outputting information. A magnetic head 1 is supported by a rotary actuator 4 via an arm 7. A suspension 8 has a function of pressing the magnetic head 1 against the recording medium 2 with a predetermined load. A signal processing circuit 5 and a recording and reproducing circuit 6 are mounted on the disk drive so as to process read signals and to input/output information.

FIG. 3 shows a conventional magnetic head that would typically be mounted on the disk storage unit of FIG. 2. In the following description, a portion of a direction toward the top of a drawing sheet, i.e., the z direction, will be referred to as “an upper portion” of the magnetic head, and a portion in a direction toward the bottom of a drawing sheet, i.e., a direction opposite to the z direction, will be referred to as “a lower portion” of the magnetic head. The magnetic head 1 moves above a recording medium 2 in accordance with rotation of a rotary actuator 4 to be located on an arbitrary position and, after that, writes or reads magnetic information. An electric circuit controlling the above operations is provided along with a signal processing circuit

The magnetic head 1 includes function units for writing and reading, which are referred to as an information write head 10 and an information read head 11. The write head 10 has coils 12, pole pieces 14, 15 that are magnetically coupled with each other, a pole piece 16 determining a track width, and an insulating film 27. The pole pieces 14, 15 are positioned in such a fashion as to enclose the coils 12 respectively from above and from below. The insulating film 27 is formed between the coils 12 and the pole pieces 14, 15, and 16.

The read head 11 includes a magnetoresistive element 19 and an electrode 20 for supplying a constant current to the magnetoresistive element 19 and detecting changes in resistance. An upper magnetic shield 17 and a lower magnetic shield 18 are located in such a fashion as to enclose the magnetoresistive element 19 and the electrode 20 and function as shields for blocking an unnecessary magnetic field at the time of reading. The read and write heads are formed on a magnetic head body 25 with an underlying layer 24 being sandwiched therebetween.

The read head shown in FIG. 3 is adapted to supply a sense current for detecting the magnetic information in a plane parallel with the shields 17 and 18. Recently, a read head having a component serving as both of the shields and the electrode has come into practical use. In the latter read head, the sense current is supplied to the magnetoresistive element in a film-thickness direction. Since the current supplying direction is perpendicular to the film, the read head is called a CPP (current perpendicular to plane) type element. No limitation is imposed on the write head including the lower pole piece 15 in the case of using the CCP element.

In recent years, a step 26 is commonly formed by selectively etching a surface of the pole piece 15 located close to the pole piece 16 for determining a track width. Examples of general step formation processes include a process in which the surface of the pole piece 15 is subjected to an ion milling with the pole piece 16 being used as a mask. In view of the high density of the disk storage unit, the magnetic head is required to achieve a sharp magnetic field gradient and a uniform magnetic field in a direction of write track width.

In order to satisfy the requirements, vigorous developments of the following are proceeding: a narrower write track width; use of high saturation magnetization material for pole pieces; narrowing of the write gap (by narrowing the distance between a lower pole piece and a pole piece for determining the track width); and a low flying height technology for reducing the distance between the magnetic head and the recording medium.

When narrowing the write gap width, an undesirable magnetic field is generated due to leakage of magnetic flux from the upper pole piece 16 to the lower pole piece 15 during write operation as illustrated in FIG. 4A, which is a cross-sectional view showing the magnetic head as viewed from the air bearing surface (ABS). When the ratio of the leaking magnetic flux increases too much, the resulting magnetic field may cause a problem in that the writing operation affects an adjacent region and erases adjacent information.

In order to reduce the amount of the leaking magnetic flux, a structure may be employed wherein the surface of the lower pole piece 15 is etched by using the upper pole piece 16 as a mask as illustrated in FIG. 4B, which is a cross-sectional view showing the magnetic head disclosed in Patent Document 1 as viewed from the air bearing surface. Using this method, it is difficult to meet the error free, high level positioning requirements between the pole piece 16 and an etching region 26.

Accordingly, a magnetic head is disclosed in Patent Document 2 as illustrated in FIG. 4C, which is a cross-sectional view showing the magnetic head as viewed from the ABS. The magnetic head disclosed in Patent Document 2 is characterized in that a lower second magnetic film 42, a non-magnetic film 41, and an upper second magnetic film 400 are successively plated on a lower first magnetic film 15. Specifically, they are layered so that the widths of the upper second magnetic film 40 and the lower second magnetic film 42 are made equal to each other. In order to achieve this, the non-magnetic film 41 for forming the write gap is also formed during the plating process.

FIGS. 9A to 9D show a manufacturing process of the magnetic head disclosed in Patent Document 2. A film 46 serving as an underlying layer for plating is formed on the lower first magnetic film 15. The film 46 may be omitted when a lower pole piece has good electroconductivity. Then, a resist pattern 45 having an opening whose width is equal to the write track width is formed (FIG. 9A). The lower second magnetic film 42 is plated on the opening by using the resist pattern as a mask (FIG. 9B). Then, the non-magnetic film 41 and the upper second magnetic film 40 are plated in this order (FIG. 9C). Lastly, the unnecessary resist pattern is eliminated to obtain the desired pole structure (FIG. 9D). After that, the plating electrode is eliminated as required.

In the pole structure achieved by the above process, the magnetic flux leakage is reduced since the distance between the upper pole piece and the lower pole piece is increased as with the structure shown in FIG. 4B of the magnetic head disclosed in Patent Document 1, and etching is unnecessary on the lower pole region (light etching may sometimes be required for the elimination of the plating electrode). Using this process, a magnetic head is produced that is greatly reduced in dimensional variation.

However, even when the distance between the upper pole piece 16 and the lower pole piece 15 is increased, the magnetic flux leakage from the upper pole piece 16 to the lower pole piece 15 still occurs in the magnetic head disclosed in Patent Document 1.

This problem will be explained with reference to FIG. 4C. Shown in FIG. 4C is the pole structure as viewed from the ABS. The magnetic flux flows from the upper pole piece 40 to the lower pole 42 via the non-magnetic film 41 to ultimately be guided to the lower core 15. In the conventional write head for low density recording, resistance and the leakage are relatively small in the magnetic circuit due to the wider track width. However, with the narrow track width of 0.2 μm or less which is employed for high density recording, the ratio of magnetic flux directly flowing into the lower core 15 from the pole 40 is increased because the magnetic passage width is limited causing an increase in magnetic resistance. Due to the passage through which the magnetic flux directly flows into the lower core 15, the undesirable magnetic field leakage is increased.

This problem has been solved, to a certain degree, by a structure disclosed in Patent Document 3 wherein the lower core is recessed from an ABS. In this structure, the lower core is not located on the ABS side while the pole piece 21, the non-magnetic film 22, and the pole piece 23 are projected above the ABS as shown in FIG. 4D.

However, this structure fails to attain a strong magnetic field. Further, a problem has been detected in that the insulating layer between the recessed lower core and the ABS is easily stripped. As a result, the structure as described has not been used in disk storage units.

### SUMMARY OF THE INVENTION

Embodiments of the present invention provide a write head structure which prevents an insulating layer from stripping and generates a ferromagnetic field suitable for high density recording, thereby addressing at least some of the problems discussed above in connection with the conventional technology.

In one aspect, a magnetic head having a write head comprises: a lower core including a plurality of layers; an upper core including a plurality of layers; a lower core edge layer included in the lower core; and an upper core edge layer included in the upper core, the lower core edge layer and the upper core edge layer defining a write gap on a side of an air bearing surface. The lower core except for the lower core edge layer is recessed from the air bearing surface of the magnetic head and has a flare structure.

In another aspect, a magnetic head having a write head comprises: a lower core having a first lower pole piece formed under coils and a second lower pole piece formed under a write gap layer; and an upper core having a first upper pole piece formed above the coils and a second upper pole piece formed above the write gap layer. The second lower pole piece is recessed from an air bearing surface of the magnetic head and has a flare structure.

In another aspect, a write head includes a lower core made from a magnetic material; an upper core made from a magnetic material; and a curled coil conductor provided between the lower core and the upper core; wherein the upper core and the lower core are magnetically coupled at rear ends of the upper core and the lower core; a gap that includes a non-magnetic film is formed on a side of an air bearing surface (ABS) which is an end opposite to the rear ends; and a write operation is realized by a magnetic field leaking from the gap. A flare is provided for the lower core on the side of the ABS, and a facet of the lower core is recessed from the ABS.

It is possible to narrow the width of the lower core near the ABS by providing a flare for the lower pole piece. As an effect of such a lower core, the volume of the region defined by the recess of the lower core from the ABS is reduced because the distance between the lower core and the ABS is reduced. As a result, mechanical strength is increased because the proportion of the non-magnetic film (usually made of alumina) is reduced, thereby allowing the non-magnetic film to be less vulnerable to being stripped.

Various embodiments may include one or more of the following features. The lower core includes a plurality of magnetic film patterns which are magnetically coupled to each other. All the magnetic film patterns of the lower core are recessed from the ABS. The upper core includes a plurality of magnetic film patterns which are magnetically coupled to each other. All the magnetic film patterns of the upper core are recessed from the ABS.

It is well known that the magnetic field of the write head depends on a magnetomotive force to be applied, a write gap length, a flying height, and a saturation magnetic flux density of a pole piece. However, the magnetic field depends much on the structure of the write head, too. According to results of our computer simulation, the increase in distance between the upper core and the lower core causes the leaking magnetic field to decrease in the element, with the result that the magnetic flux guided to the ABS is increased, resulting in generation of a high magnetic field from the write gap.

Accordingly, when at least one of the lower core or the upper core has the structure wherein a plurality of structural bodies (pedestal pole pieces or magnetically coupled patterned magnetic materials) are stacked, it is possible to increase the distance between the upper and lower cores and, as an effect of the increased distance, to attain a ferromagnetic field.

It is possible to concentrate the magnetic flux on the pole serving to determine the write track width by providing the flare to the lower core. As a result of the concentration, a strong magnetic field is also attained.

A thickness of the non-magnetic film which defines the write gap is increased at a region recessed from the ABS.

The write head is provided with a first non-magnetic film pattern for forming the write gap and a second non-magnetic pattern at least overlapping with the first non-magnetic pattern and having its end located at a position recessed from the ABS.

The write gap comprises the non-magnetic film, and it is possible to increase a magnetic path resistance by increasing the thickness of the non-magnetic film. By increasing the thickness of the region of the write gap remote from the ABS, the magnetic flux flows more smoothly to the side of the ABS where the magnetic passage resistance is reduced (where the non-magnetic film is thinner). Owing to this effect, it is possible to generate the ferromagnetic field.

While the present invention relates to the write head structure, it is possible to realize a magnetic head for high density magnetic disks by combining the write head of the present invention and a read head having, as its read element, a gigantic magnetoresistive element (GMR element), a tunneling magnetoresistive element (TMR element), or a CPP (current perpendicular to plane) type element which is adapted to feed a sense current in a direction of film thickness to a magnetoresistive element.

A further understanding of the nature and advantages of the present invention may be realized by reference to the remaining portions of the specification and the drawings.

### BRIEF DESCRIPTION OF THE DRAWINGS

FIG. 1 is a conceptual diagram showing a section of a magnetic head according to a first embodiment of the present invention as viewed from a direction diagonal to an air bearing surface (ABS);

FIG. 2 includes top plan and side views showing a basic structure of a magnetic disk drive in which a conventional magnetic head or a magnetic head of the present invention is used;

FIG. 3 is a diagram of a conventional magnetic head;

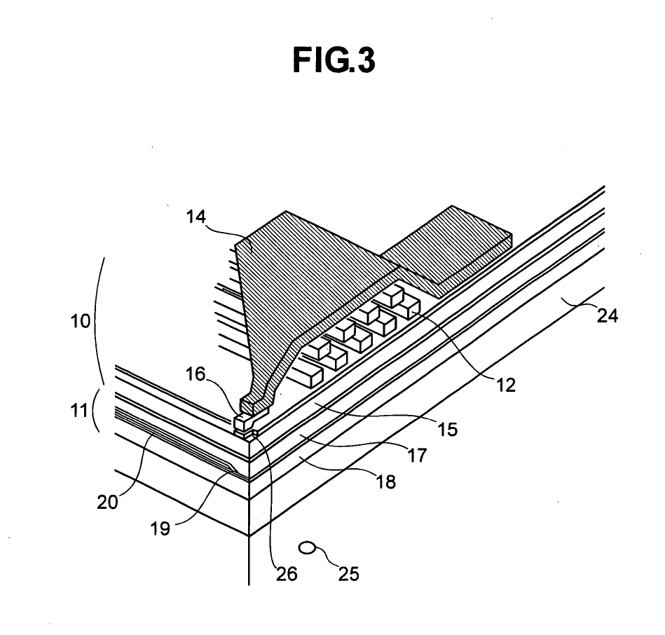

FIGS. 4A to 4D are diagrams illustrating problems of the conventional technology and a difference between the conventional technology and the present invention;

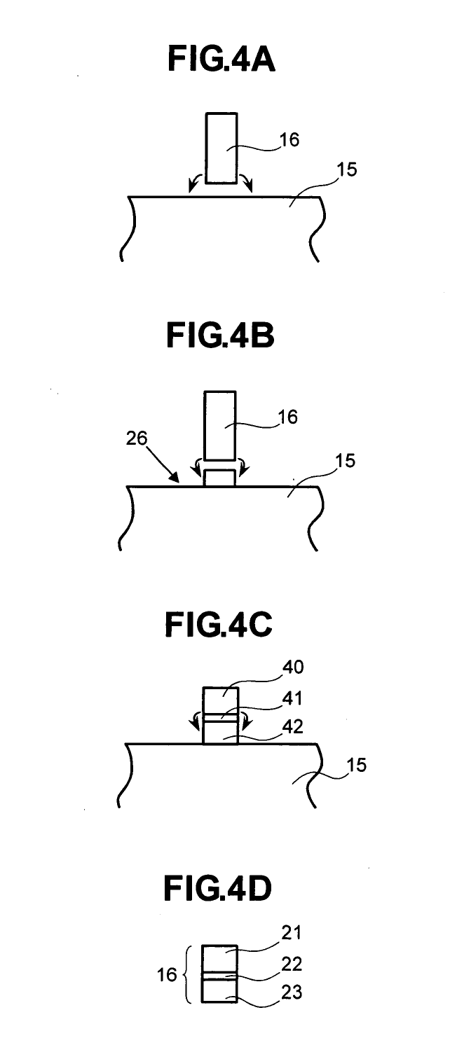

FIG. 5 is a conceptual diagram showing a section of a magnetic head according to a fourth embodiment of the present invention as viewed from a direction diagonal to an ABS;

FIG. 6 is a conceptual diagram showing a section of a magnetic head according to a fifth embodiment of the present invention as viewed from a direction diagonal to an ABS;

FIGS. 7A and 7B are conceptual diagrams each showing a section of a magnetic head according to a second embodiment of the present invention as viewed from a direction perpendicular to an ABS;

FIGS. 8A to 8C are conceptual diagrams each showing a section of a magnetic head according to a third embodiment of the present invention as viewed from a direction perpendicular to an ABS;

FIGS. 9A to 9D are diagrams showing a manufacturing process of the magnetic head disclosed in Patent Document 2;

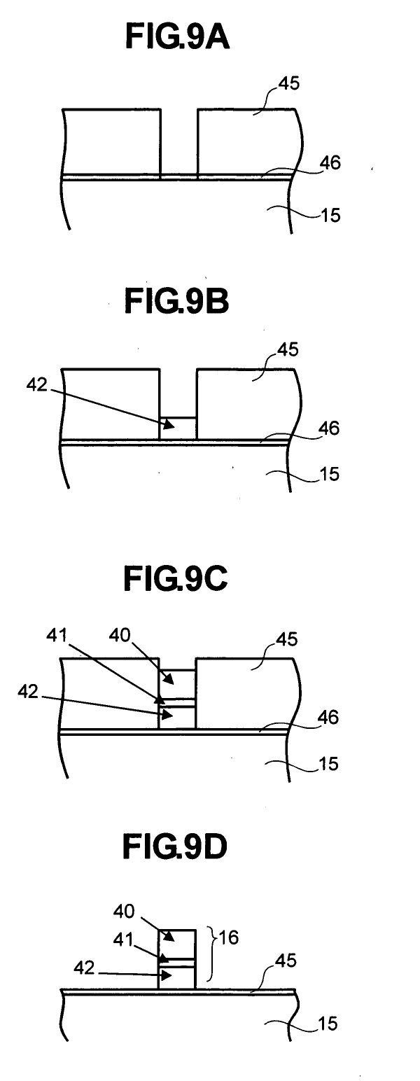

FIGS. 10A and 10B are conceptual diagrams each showing a section of a magnetic head according to a third embodiment of the present invention as viewed from a direction perpendicular to an ABS;

FIGS. 11A and 11B are conceptual diagrams each showing a section of a magnetic head according to a sixth embodiment of the present invention as viewed from a direction perpendicular to an ABS; and

FIGS. 12A and 12B are conceptual diagrams showing a section of a magnetic head according to a seventh embodiment of the present invention as viewed from a direction perpendicular to an ABS.

### DESCRIPTION OF SPECIFIC EMBODIMENTS

Embodiments of the present invention will hereinafter be described with respect to the drawing figures. The following is a table of reference numerals.

| | |
|---|---|
| 1 | magnetic head |
| 2 | recording medium |
| 3 | motor |
| 4 | rotary actuator |
| 5 | circuit substrate |
| 6 | recording and reproducing |
| | circuit |
| 7 | arm |
| 8 | suspension |
| 10 | write head |
| 11 | read head |
| 12 | coils |
| 14 | first upper magnetic film (upper |
| | pole piece) |
| 15 | first lower magnetic film (lower |
| | pole piece) |
| 16 | pole piece for defining track |
| | width |
| 17, 18 | shields |
| 19 | magnetoresistive film |
| 20 | electrode |
| 21 | second upper magnetic film |
| 22 | non-magnetic film |
| 23 | second lower magnetic film |
| 24 | underlying film |
| 25 | substrate (slider) |
| 26 | step |
| 27, 29 | insulating films |
| 28 | pedestal pattern |
| 30 | air bearing surface (ABS) |
| 31, 32, 51 | non-magnetic films |
| 36, 37 | soft magnetic film patterns |
| 40 | second upper magnetic film |
| 41 | non-magnetic film |
| 42 | second lower magnetic film |
| 43 | bump |
| 45 | resist pattern |
| 46 | plating underlying film |
| 52 | soft magnetic film pattern |
| 53 | non-magnetic film |
| 119 | CPP element |
| 120 | terminal |
| 121 | permanent magnetic pattern |

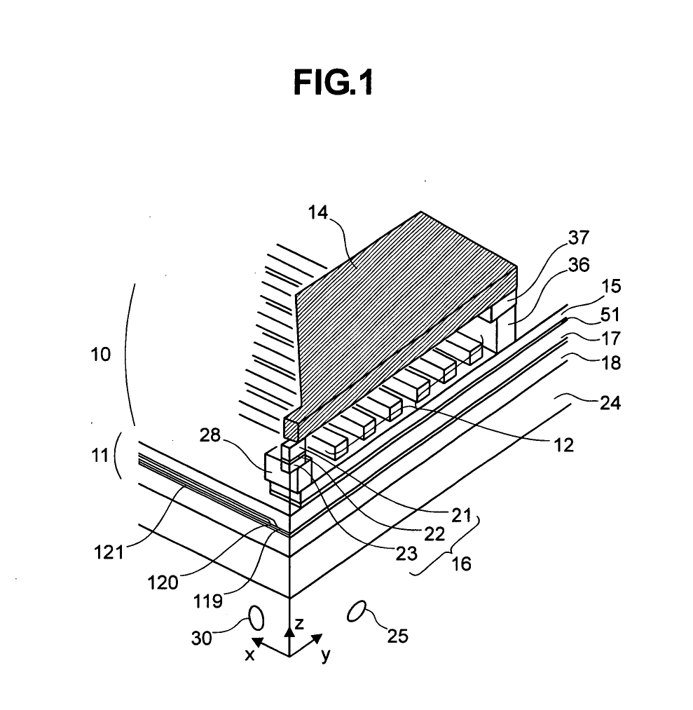

FIG. 1 is a conceptual diagram showing a section of a magnetic head of a first embodiment of the present invention as viewed from a direction diagonal to an air bearing surface(ABS). The magnetic head includes a substrate 25 made from Al₂O₃—TiC (the same as a slider material), an underlying layer 24 made from, e.g.,Al₂O₃—TiC, and formed on the substrate 25, and a read head 11 formed on the underlying layer 24 for reading information.

The read head 11 has an upper magnetic shield 17 and a lower magnetic shield 18 respectivly formed above and below the read head 11. The upper and lower magnetic shields 17 and 18 serve also as electrodes for introducing a current to a CPP element 119 in this embodiment. A terminal 120 is placed between the CPP element 119 and the shields used also as the electrodes. A permanent magnet pattern 121 is provided in the vicinity of the CPP element as a magnetic domain controlling layer for a free layer constituting the CPP element 119.

No influence is imposed on a write head 10 when a giant magnetoresistive element (GMR) is used as the read head 11 as described in the foregoing, and it is apparent that the use of GMR element causes no problem in realizing the present invention.

In this embodiment, the write head 10 is formed after a non-magnetic film 51 is stacked. The non-magnetic film 51 has an effect of blocking a magnetic coupling between a pole 15 forming a magnetic passage at the time of write operation and the shield 17 forming the read head 11, thereby achieving an effect of reducing fluctuation in output at the time of read operation.

The write head 10 includes a first upper magnetic film 14, a first lower magnetic film 15, a pole piece 16 for defining a track width, coils 12, and an insulating film 27. The magnetic films 14 and 15 are magnetically coupled with each other. The coils 12 are formed between the first and second upper magnetic films 14 and 15. The insulating film 27 is formed between the magnetic films 14, 15 and the coils 12.

The pole piece 16 for defining a track width includes a second upper magnetic film 21, a non-magnetic film 22, and a second lower magnetic film 23. The second upper magnetic film 21 of the pole piece 16 is magnetically coupled with the first upper magnetic film 14, and the second lower magnetic film 23 is magnetically coupled with the first lower magnetic film 15 via a pedestal pattern 28, which will be described later in this specification. A facet on an ABS side of the pole piece 16 is exposed to an ABS (x-z plane) of the magnetic head, and the first upper magnetic film 14, the first lower magnetic film 15, and the pedestal pattern 28 are recessed from the ABS by a predetermined length.

In this embodiment, the pedestal pattern 28 made of a soft magnetic film is provided on the first lower magnetic film 15, and the pole piece 16 for defining a track width is formed thereon. With this structure, the pole piece 16 for defining a read track width is formed by a common resist pattern including a write gap, and, therefore, a need for etching (also called trimming) on the first lower magnetic film 15 is eliminated to thereby attain a highly accurate track width.

The pedestal pattern 28 and the lower first magnetic film 15 are magnetically coupled with each other, and their facets are recessed from the ABS. Since the pedestal pattern 28 and the lower first magnetic film 15 do not reach the ABS, it is possible to prevent a magnetic field leaking from the pedestal pattern 28 and the first lower magnetic film 15 from influencing on an adjacent track even when a magnetic field in the pole piece 16 is saturated.

The coils 12 are located, in the z direction of FIG. 1, in the range in which the pedestal pattern 28 and the pole 16 for defining track width are located. In order to achieve this structure, soft magnetic films 36 and 37 for forming a magnetic path at the rear end of the first upper magnetic film 14 are provided. The soft magnetic film 36 may be formed at a position corresponding to the pedestal pattern 28 in the z direction. The soft magnetic film 37 may be located at a position corresponding to the pole piece 16 for defining a track width in the z direction. In view of the suppression of magnetic passage resistance, a single magnetic film without non-magnetic film is used as the soft magnetic film 37.

After forming such a structure, a polymer resin (resist), an alumina film, or an insulating layer containing silicon oxide and the like is stacked, and then etching is performed on a surface thereof by the chemical mechanical etching method or the like, followed by forming the first upper magnetic film 14 on the surface. An end on the ABS side of the upper first magnetic film 14 is also recessed from the ABS. Thus, it is possible to prevent a magnetic field generated from the first upper magnetic film 14 from influencing on an adjacent track.

In addition, conventional structures of a magnetic head for achieving functions such as current introduction to the coils, current introduction to the read head 11, a protection film for ensuring the element reliability, flying of the magnetic head above a surface of medium, and the like are used for realizing the magnetic head of the present invention.

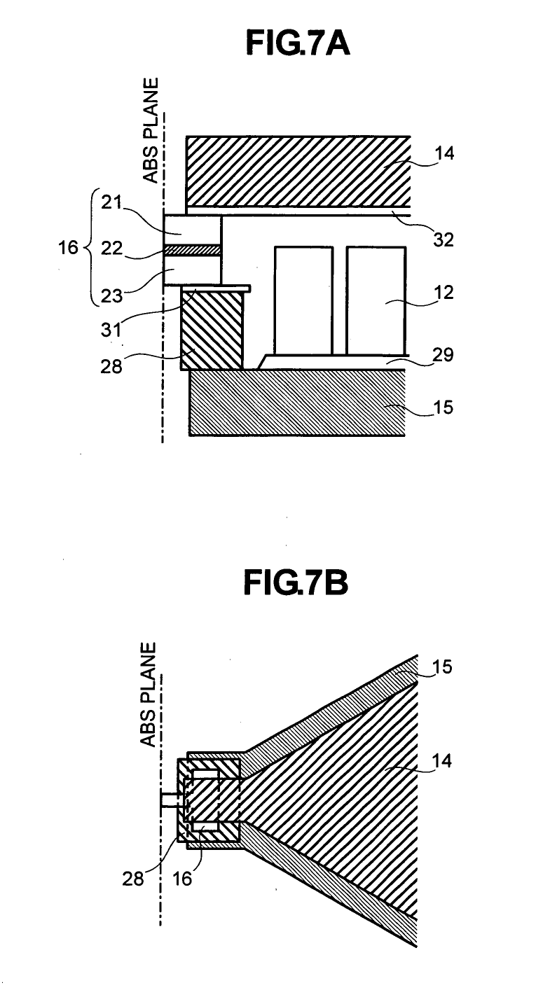

A magnetic head of a second embodiment will be described with reference to FIGS. 7A and 7B. FIG. 7A is a cross-sectional view showing a z-y section of the head tip near the ABS of FIG. 1 of the first embodiment. Both of a pedestal pattern 28 and a first lower magnetic film 15 are recessed from an ABS. In this embodiment, the recession of the lower first magnetic film 15 is greater than the recession of the pedestal pattern 28; however, the recession of the lower first magnetic film 15 may be less than that of the pedestal pattern 28 or the recessions may be identical with each other. The pole piece 16 for defining a track width is formed on the pedestal pattern 28 via a non-magnetic film 31. In addition, the non-magnetic film 31 is flat.

A non-magnetic film 32 is also formed on the pole piece 16 for defining a track width. By forming the non-magnetic films 31 and 32, a magnetic flux is guided to an end on the ABS side of the pole piece 16 for defining a track width, thereby improving positioning accuracy of the magnetic film patterns.

The coils 12 are disposed on the first lower magnetic film 15 via an electrical insulation layer 29. A thickness of each of the coils is less than the thicknesses of the pedestal pattern 28 and the pole piece 16 for defining track width in the z direction while it is made as large as possible within the thicknesses in order to suppress ohmic heating of the coils. An insulating film 27 is formed also between the first upper and the first lower magnetic film 14, 15 and the coils 12.

FIG. 7B is a plan view schematically showing a portion of the magnetic head near the ABS as viewed from above. In this embodiment, since the front end of each of the upper first magnetic film 14, the pedestal pattern 28, and the first lower magnetic film 15 is recessed from the ABS, an insulating material (alumina in this embodiment) exists on a region provided by the recession.

When an amount of the recession is relatively small (from 0.5 to 0.7 μm in this embodiment) and the ABS is formed of a thin insulating film, it is highly desirable (or perhaps even necessary) to narrow the region (the region as viewed from the ABS side) on which the thin insulating layer is formed as much as possible in order to prevent the thin insulating layer from stripping. In this embodiment, a width, in the direction of track width, of the pedestal pattern 28 is narrowed, and the end of the first lower magnetic film 15 to be coupled with the pedestal pattern 28 is formed in such a fashion as to satisfy the positioning accuracy required in the thin film formation process.

As shown in FIG. 7B, since the plane shape of the pedestal pattern 28 is identical with the plane shape of the front end of the first lower magnetic film 15 and the widths, in the direction of track width, of the pedestal pattern 28 and the first lower magnetic film 15 are narrowed, it is possible to prevent the thin insulating layer from stripping by narrowing the region on which the insulating layer is formed, thereby ensuring the reliability. Further, the first lower magnetic film 15 has a flare structure wherein it is widened along the Y axis direction. Owing to the flare structure of the first lower magnetic film 15 and the flare structure of the first upper magnetic film 14, it is possible to concentrate a magnetic flux on the pole piece 16, thereby forming a magnetic path for generating a ferromagnetic field. In addition, while forming the ABS with the thin insulating layer, it is possible to ensure the reliability by improving reliability of the material of the insulating layer.

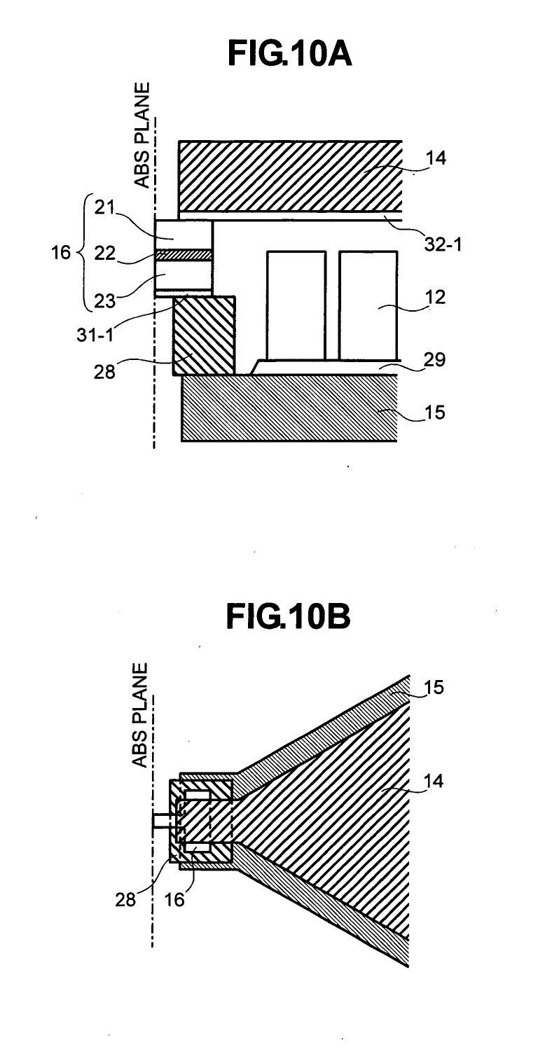

Although the non-magnetic films 31 and 32 are used as the underlying layer for the pole pattern (pole piece 16) in this embodiment, no problem will occur when a magnetic film 31-1 is used in place of the non-magnetic film 31 as shown in FIGS. 10A and 10B. In this case, the magnetic film 31-1 is used as a seed layer, and a pole piece 23, a non-magnetic film 22, and a pole piece 21 are successively plated using a single resist pattern as a mask, followed by performing etching on the magnetic film 31-1 which is the underlayer with the pole patterns being used as a mask. Although the positioning accuracy is reduced by using the magnetic film as the underlying layer, the magnetic film has an effect of reducing a magnetic path resistance between the pedestal pattern 28 and the pole piece 23 (a ferromagnetic field is attained).

Further, a magnetic film 32-1 may be inserted under the first upper magnetic film for the same reason. Also in this case, the magnetic film 32-1, which will be an underlying layer, is used as a seed layer in plating the first upper magnetic film 14.

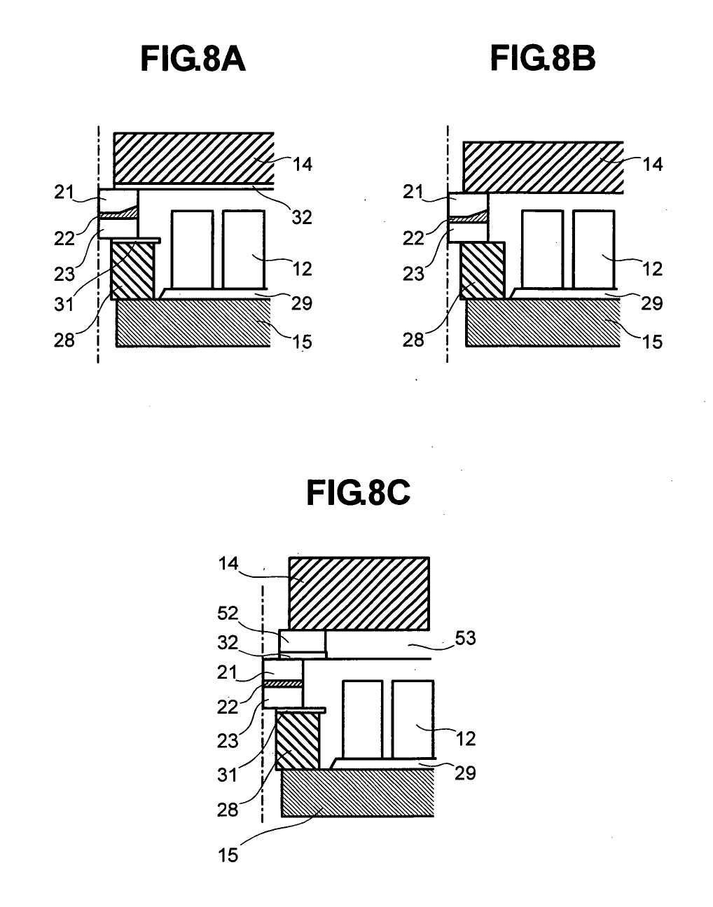

FIGS. 8A to 8C are conceptual diagrams each showing a section of a magnetic head according to a third embodiment of the present invention as viewed from a direction perpendicular to an ABS. As shown in FIG. 8A, a thickness of a non-magnetic film 22, which is part of a pole piece 16 for defining a track width is increased at a region recessed from an ABS. Accordingly, a magnetic passage resistance is reduced on a side of the ABS so that a magnetic flux is guided closer to the ABS. Therefore, it is possible to achieve a ferromagnetic field at the ABS.

As shown in FIG. 8B, it is possible to guide a strong magnetic field to the ABS when a first lower magnetic film 14 and a first upper magnetic film 15 are magnetically coupled with the pole piece 16 for defining a track width.

A method of varying areas of regions of resist pattern may be used as means for providing the non-magnetic film 22 with the thickness difference. In this embodiment, a plane shape of the pole piece 16 for defining a track width shown in FIG. 7B is a convex wherein the region on the ABS side is narrowed and the region remote from the ABS is widened. When electrical plating is performed on this shape, speeds of the plating growths of the wider region and the narrower region vary from each other to spontaneously cause the film thickness difference (the so-called loading effect). Under the narrow gap conditions, it is necessary to adopt means which are retrogressive to the conventional processes for maintaining uniformity of film thickness such as the use of direct current plating and the adjustment of plating liquid composition in order to increase the difference.

Further, as shown in FIG. 8C, it is possible to magnetically couple the first upper magnetic film 14 with the pole 16 for defining a track width with a soft magnetic film 52 being sandwiched therebetween. Since the soft magnetic film 52 is formed, it is possible to form another non-magnetic film 53 at a position corresponding to the soft magnetic film 52 in the z direction. Accordingly, it is possible to increase dielectric strength between the coils 12 and the upper first magnetic film 14 when a dielectric constant of the non-magnetic film 53 is increased. Further, by using a polymer resin for the non-magnetic film 53, it is possible to absorb a mechanical stress generated when the first upper magnetic film 14 is formed. Thus, the effects of improving the soft magnetic properties of the first upper magnetic film 14 and reducing the influence of the mechanical strength to be exerted on the read head 11 and the like are achieved.

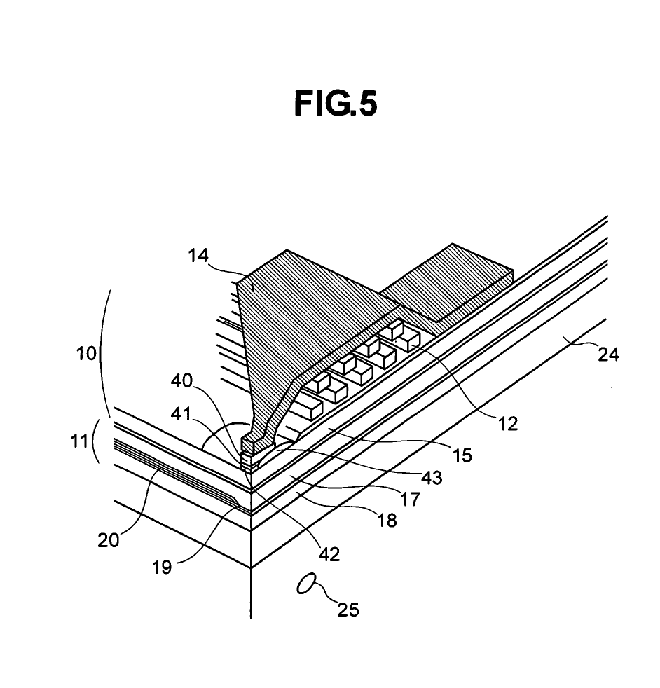

FIG. 5 is a conceptual diagram showing a section of a magnetic head according to a fourth embodiment of the present invention as viewed from a direction diagonal to an ABS. The magnetic head of this embodiment is characterized in that a rear end of a pole piece 16 for defining a track width partially overlaps with a bump 43 formed of an insulating film (structures of magnetic films 14, 15 and coils 12 are the same as those of other embodiments). With this structure, since an area of the contact between a non-magnetic film 41 and a second lower magnetic film 42 is smaller than that of the contact between the non-magnetic film 41 and a second upper magnetic film 40, a magnetic flux passing through the second upper magnetic film 40 is guided toward a direction in which the second lower magnetic film 42 is located. From this effect, the magnetic flux is concentrated on an ABS side on which the lower magnetic film is positioned, thereby attaining a ferromagnetic field.

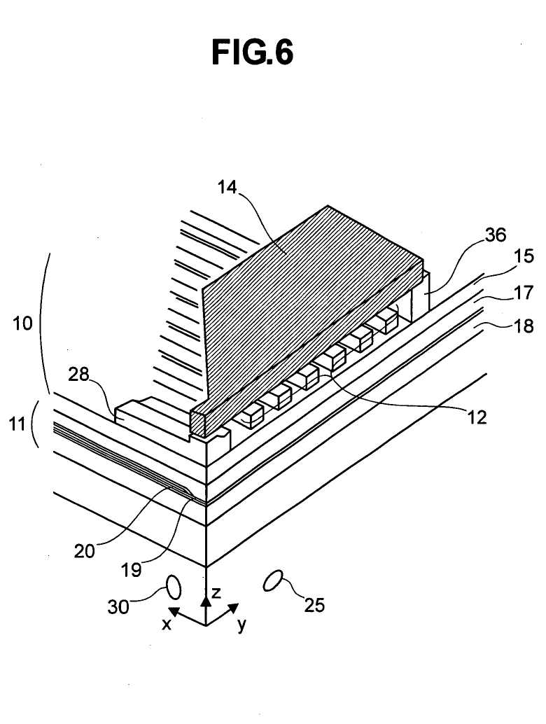

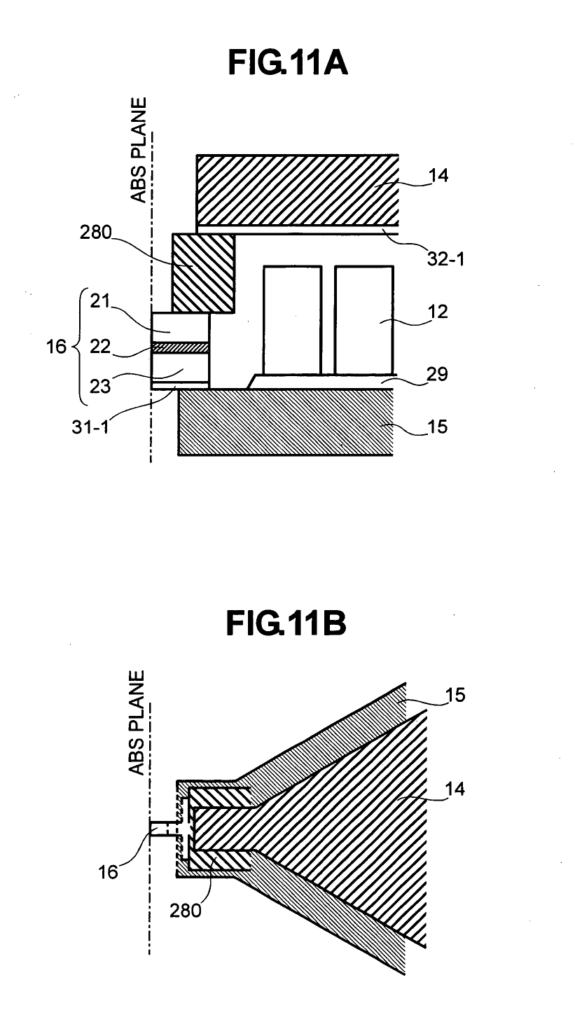

FIG. 6 is a conceptual diagram showing a section of a magnetic head according to a fifth embodiment of the present invention as viewed from a direction diagonal to an ABS. As shown in FIG. 6, the present invention is applicable to a structure wherein a surface of a lower pole piece 15 is subjected to etching with an upper pole piece 14 being used as a mask. Since an end, on a side of an ABS, of the lower pole piece 15 is recessed from the ABS, it is possible to suppress an influence to be exerted by a magnetic flux on an adjacent track even when the magnetic flux leaks from the upper pole piece 14 to the lower pole piece 15. FIGS. 11A and 11B are conceptual diagrams each showing a section of a magnetic head according to a sixth embodiment of the present invention as viewed from a direction perpendicular to an ABS. This embodiment illustrates the fact that although the lower core of the foregoing embodiments includes a plurality of magnetic film patterns, the present invention can be applied to a write head wherein the upper core includes a plurality of magnetic film patterns. A magnetic body 280 exists under a first upper magnetic film 14 with an underlying film 32-1 (either one of non-magnetic or magnetic film is used as the underlayer film 32-1) being sandwiched therebetween. The magnetic body 280 is magnetically coupled with a second upper magnetic film 21 for defining a track width. The magnetic body 280 of this embodiment is also recessed from an ABS plane by a predetermined length, and a pole piece 16 and an underlying film 31-1 are exposed to the ABS plane to form part of the ABS plane. Also, a first lower magnetic film 15 has a flare structure, which is the same as the other embodiments. In this embodiment, since it is unnecessary to form a pole piece for defining a track width, which is a fine dimension, on a pedestal pattern, a benefit of forming the track width with high precision is attained.

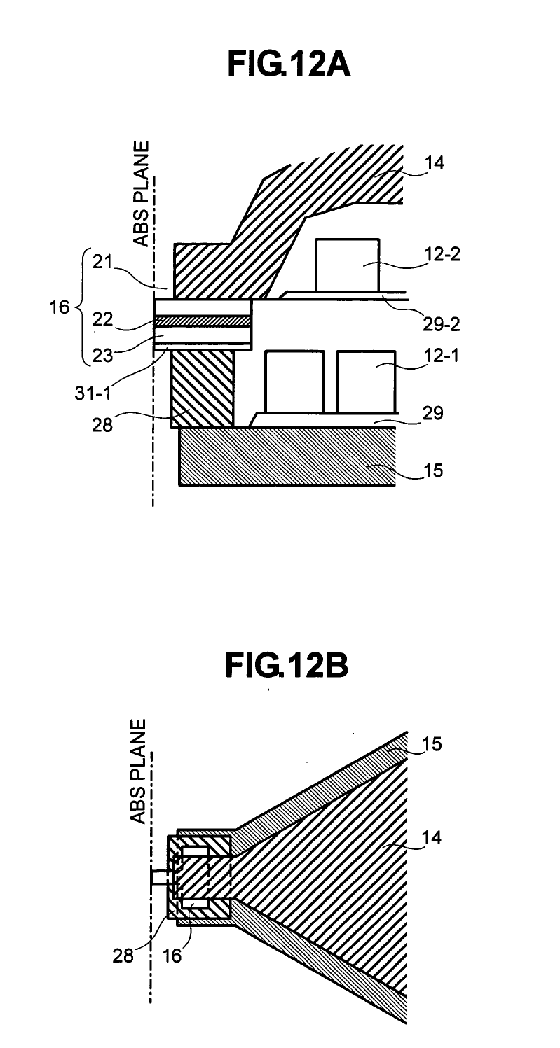

FIGS. 12A and 12B are conceptual diagrams showing a section of a magnetic head according to a seventh embodiment of the present invention as viewed from a direction perpendicular to an ABS. This embodiment illustrates how the present invention is applicable to a magnetic head having two-layer coils. Specifically, first layer coils 12-1 are formed on an insulating layer 29, and second layer coils 12-2 are formed on an insulating layer 29-2. The insulating layer 29-2 will be used when a trouble occurs with the contact between the first layer coil insulating layer and the second layer coils and, therefore, it is not essential for realizing the present invention. A lower structure includes a first lower magnetic film 15 and a pedestal pattern 28 also in this embodiment, and a distance between an upper core 14 and a lower core 15 is increased owing to the structure.

Since the lower core 15 and the pedestal pattern 28 are recessed from an ABS plane, an effect of reducing an adverse effect otherwise caused by a leaked magnetic field to be exerted on an adjacent track is attained.

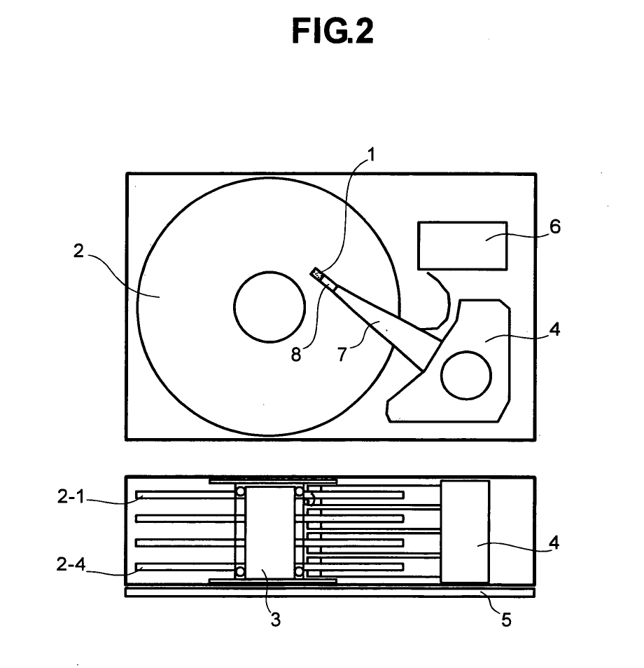

As mentioned above magnetic heads according to embodiments of the invention can be mounted in a disk drive of the type shown in FIG. 2.

Thus it can be seen that embodiments of the present invention provide a magnetic head capable of preventing a magnetic flux leakage and of suitable use for achieving high recording density.

While the above is a complete description of specific embodiments of the invention, the above description should not be taken as limiting the scope of the invention as defined by the

What is claimed is:

1. A magnetic head having a write function, comprising:
a lower core including a plurality of layers;
an upper core including a plurality of layers;
a lower core edge layer included in the lower core; and
an upper core edge layer included in the upper core, the lower core edge layer and the upper core edge layer defining a write gap on a side of an air bearing surface;
wherein the lower core except for the lower core edge layer is recessed from the air bearing surface of the magnetic head and has a flare structure.

2. The magnetic head according to claim 1, wherein an insulating film is formed on the lower core except for the lower core edge layer on a side of the air bearing surface.

3. The magnetic head according to claim 1, wherein a three-layer pole piece having the lower core edge layer, the upper core edge layer, and a write gap layer formed between the lower core edge layer and the upper core edge layer is configured such that a width in the track width direction of a side opposite to the side of the air bearing surface is larger than a width in the track width direction on the side of the air baring surface.

4. The magnetic head according to claim 1, wherein a non-magnetic layer in the write gap between the lower core edge layer and the upper core edge layer is formed such that a thickness of a region opposite to a side of the air bearing surface is larger than a thickness of a region on the side of the air bearing surface.

5. A magnetic head having a write function, comprising:
a lower core having a first lower pole piece formed under coils and a second lower pole piece formed under a write gap layer; and
an upper core having a first upper pole piece formed above the coils and a second upper pole piece formed above the write gap layer;
wherein the second lower pole piece is recessed from an air bearing surface of the magnetic head and has a flare structure.

6. The magnetic head according to claim 5, wherein:
a patterned magnetic material is formed between the first lower pole piece and the second lower pole piece, and
the first lower pole piece is recessed from a facet of the patterned magnetic material on a side of the air bearing surface of the magnetic head.

7. The magnetic head according to claim 5, wherein:
the patterned magnetic material is formed between the first upper pole piece and the second upper pole piece, and
he first upper pole piece is recessed from a facet of the patterned magnetic material on a side of the air bearing surface of the magnetic head.

8. The magnetic head according to claim 5, wherein a three-layer pole piece having the second lower pole piece, the second upper pole piece, and the write gap layer formed between the second lower pole piece and the second upper pole piece is configured such that a width in a track width direction of a side opposite to a side on the air bearing surface of the three-layer pole piece is larger than a width in the track width direction on the side of the air bearing surface.

9. The magnetic head according to claim 5, wherein the write gap layer is a non-magnetic layer formed such that a thickness of a region opposite to a side of the air bearing surface is larger than a thickness of a region on the side of the air bearing surface.

10. The magnetic head according to claim 5, wherein a non-magnetic film pattern is formed at least under the second lower pole piece or above the second upper pole piece, and the non-magnetic film pattern has its facet located at a position recessed from the air bearing surface.

11. The magnetic head according to claim 5, wherein a magnetic film is formed as an underlying layer under the second lower pole piece.

12. A magnetic head having a write head, comprising:
a multi-layer lower core including a lower core edge layer; and
a multi-layer upper core including an upper core edge layer;
wherein:
the lower core edge layer and the upper core edge layer define a write gap on a side of an air bearing surface; and
the lower core except for the lower core edge layer is recessed from the air bearing surface of the magnetic head and has a flare structure.

13. The magnetic head according to claim 12, wherein an insulating film is formed on the lower core except for the lower core edge layer on a side of the air bearing surface.

14. The magnetic head according to claim 12, and further comprising a write gap layer formed between the lower core edge layer and the upper core edge, the lower core edge layer, the upper core edge layer, and the write gap layer defining a three-layer pole piece;
the three-layer pole piece being configured such that a width in the track width direction of a side opposite to the side of the air bearing surface is larger than a width in the track width direction on the side of the air bearing surface.

15. The magnetic head according to claim 12, and further comprising a non-magnetic write gap layer between the lower core edge layer and the upper core edge layer;
the non-magnetic write gap layer being formed such that a thickness of a region opposite to a side of the air bearing surface is larger than a thickness of a region on the side of the air bearing surface.

16. A magnetic head having a write head, comprising:
a set of coils;
a lower core having a first lower pole piece formed under the coils;
a a non-magnetic write gap layer;
a second lower pole piece formed under the write gap layer; and
an upper core having a first upper pole piece formed above the coils and a second upper pole piece formed above the write gap layer;
the second lower pole piece is recessed from an air bearing surface of the magnetic head and has a flare structure.

17. The magnetic head according to claim 16, wherein:
a patterned magnetic material is formed between the first lower pole piece and the second lower pole piece, and
the first lower pole piece is recessed from a facet of the patterned magnetic material on a side of the air bearing surface of the magnetic head.

18. The magnetic head according to claim 16, wherein:
the patterned magnetic material is formed between the first upper pole piece and the second upper pole piece, and
the first upper pole piece is recessed from a facet of the patterned magnetic material on a side of the air bearing surface of the magnetic head.

19. The magnetic head according to claim 16, wherein:
the second lower pole piece, the write gap layer, and the second upper pole piece define a three-layer pole piece that is configured such that a width in a track width direction of a side opposite to a side on the air bearing surface of the three-layer pole piece is larger than a width in the track width direction on the side of the air bearing surface.

20. The magnetic head according to claim 16, wherein the write gap layer is formed such that a thickness of a region opposite to a side of the air bearing surface is larger than a thickness of a region on the side of the air bearing surface.

21. The magnetic head according to claim 16, wherein:
a non-magnetic film pattern is formed at least under the second lower pole piece or above the second upper pole piece, and
the non-magnetic film pattern has its facet located at a position recessed from the air bearing surface.

22. The magnetic head according to claim 16, wherein a magnetic film is formed as an underlying layer under the second lower pole piece.
